(19) United States
(12) Patent Application Publication
(10) Pub. No.: US 2002/0128851 A1
(43) Pub. Date: Sep. 12, 2002

(54) Method and system for automating product registration

(75) Inventors: Thomas E. Chefalas, Somers, NY (US); Ajay Mohindra, Yorktown Heights, NY (US)

Correspondence Address: Richard L. Catania, Scully, Scott, Murphy & Presser, 400 Garden City Plaza, Garden City, NY, 11530, US

(73) Assignee: International Business Machines Corporation, Armonk, NY (US)

(21) Appl. No.: 09/802,248

(22) Filed: Mar. 8, 2001

(51) Int. Cl. G06F 17/60

(52) U.S. Cl. 705/1

(57) ABSTRACT

The present invention provides a method and system for automating product registration of one or more products by transmitting product registration information generated at the time of purchase respectively to one or more manufacturers for subsequent completion of the registration of the one or more products automatically by the one or more manufacturers or by the customer.

### BACKGROUND OF THE INVENTION

1. Field of the Invention

The present invention relates generally to the registration of purchased products, and more particularly to a method and system for automating product registration of purchased products via a communication network.

2. Description of the Related Prior Art

Generally, product registration is a process by which an owner of a newly purchased product completes a registration form provided by a manufacturer of the product and submits it to the manufacturer. The registration form provides for input of product registration information by the owner, which generally includes owner's personal information, product information and owner's demographic information. A primary use of product registration information is to entitle the owner to a product warranty and provide the manufacturer with a means to enforce the product warranty for the newly purchased product. The manufacturer may further utilize the owner's personal and demographic information (e.g., age, gender, income, residence, and the like) for performing demographic, market and other types of analysis. Additionally, the manufacturer may use product registration information for notifying the owner of: updates to the newly purchased product; product safety information for the newly purchased product; and other new products or special announcements. Furthermore, product registration may serve as a conduit between the owner and the manufacturer for providing owner's comments on the newly purchased product.

FIG. 1 is an exemplary representation of a typical product purchase scenario, whereby customer 100 purchases a product from seller 110. Seller 110 may be an e-commerce Website 102 (e.g., a retail Website), retail store 104, mail-order catalog 106 or auction 108. Typically, seller 110 requests some form of personal or customer information (described herein with respect FIG. 2) to enable customer 100 to make a purchase. For example, at a point of sale in retail store 104, customer 100 generally is asked to provide a customer's telephone number, or name and address. When customer 100 purchases a product online from retail Website 102, mail-order catalog 106 or auction 108, customer 100 generally provides seller 110 with customer contact information (e.g., telephone, name and address of customer), billing information (e.g., credit card number of customer) and shipping information, or a combination thereof. Conventionally, upon completion of a sale, the purchased product is shipped to customer 100 at the aforementioned shipping address from seller 110 or directly from the manufacturer, or is directly downloaded to customer's personal computer in cases of software products.

FIG. 2 illustratively depicts a prior art product registration form 200, which includes typical information requested by a manufacturer of the product. The information typically requested includes: product information 202, customer contact information 204, product purchase information 208 and customer survey information 210.

FIG. 3 is an exemplary representation of a prior art product registration process. Upon receipt of the purchased product from seller 110 of FIG. 1, the customer opens the product (or installs the software product on a computer) and obtains a product registration form 200 of FIG. 2, which is provided with the product. Conventionally, customer 100 fills out a printed product registration form (e.g., FIG. 2) provided with the product and mails the form 306 using conventional mail to the manufacturer. Alternatively, customer 100 may fill out and electronically submit an electronic product registration form via a computer by either filling out an automatic product registration instantiated by installation of the software product or by logging onto a manufacturer's Website 302, or contact the manufacturer by telephone 304 and provide requisite information, as depicted in FIG. 2.

Generally, the information that is provided at product registration time on the product registration form is redundant information that has already been provided at the time of purchase via the foregoing purchasing scenario described with regard to the description of FIG. 1. Furthermore, the conventional product registration process described herein above often leads to products being unregistered. Invariably, because of a customer's reluctance or aversion to fill out a product registration form or forgetfulness to do so, many products remain unregistered. As a consequence of unregistered products, the manufacturer cannot easily enforce product warranty and perform demographic, market and other types of research for which product registrations are crucial.

Based on the foregoing, it is highly desirable to provide a method and system for automating product registration by utilizing information recorded at the time of purchase for product registration purposes, thereby virtually eliminating the need for the customers to formally and proactively perform product registration by providing redundant product registration information.

### SUMMARY OF THE INVENTION

It is therefore an object of the present invention to increase the likelihood of manufacturers receiving a greater number of product registrations by customers.

It is another object of the present invention to automate product registration of one or more customer-purchased products by automatically transmitting information recorded at the time of purchase respectively to one or more manufacturers for subsequent completion of the registration of the one or more products.

It is a further object of the present invention to fully automate product registration by automatically registering one or more products with respective one or more manufacturers by transmitting information recorded at time of purchase.

Thus according to an embodiment of the present invention, there is provided a method for automating a product registration for one or more products purchased by a customer from a seller with one or more manufacturers of the one or more products, comprising: acquiring customer information at a time of customer purchase of the one or more products; generating product registration information for a manufacturer; transmitting from the seller via a communication network to the manufacturer the product registration information; and completing product registration of at least one of the one or more products at the manufacturer by utilizing the product registration information thereby transmitted.

According to another embodiment of the present invention, there is provided a system for automating via a communication network product registration of one or more products purchased by a customer from a seller with one or more manufacturers of the one or more products, comprising: a device for accumulating product registration information relating to the one or more products purchased by the customer and for communicating via the network the product registration information to a manufacturer; a device for receiving and storing at the manufacturer the product registration information for registration completion; a device for completing the product registration of at least one of said one or more products for the manufacturer, wherein said completing is performed by the customer or the manufacturer.

According to yet another embodiment of the present invention, there is provided a program storage device readable by a machine, tangibly embodying a program of instructions, executable by the machine to perform method steps for automating a product registration for one or more products purchased by a customer from a seller with one or more manufacturers of the one or more products, comprising: acquiring customer information at a time of customer purchase of the one or more products; generating product registration information for a manufacturer; transmitting from the seller via a communication network to the manufacturer the product registration information; wherein completion of product registration of at least one of the one or more products at the manufacturer is accomplished by utilizing the product registration information thereby transmitted.

### BRIEF DESCRIPTION OF THE DRAWINGS

The objects, features and advantages of the present invention will become apparent to one skilled in the art, in view of the following detailed description taken in combination with the attached drawings, in which:

FIG. 1 is an exemplary representation of various prior art means for buying a product.

FIG. 2 is an exemplary representation of prior art product registration form, displaying typical information requested by a manufacturer of the product.

FIG. 3 is an exemplary representation of prior art means for performing product registration.

FIG. 4 is an exemplary representation of system architecture according to the present invention.

FIG. 5 is an exemplary illustration of a sequence of steps for product registration at a point of sale according to the present invention.

FIG. 6 is an exemplary illustration of a sequence of steps for completing product registration via a manufacturer's Website according to an embodiment of the present invention.

FIG. 7 is an exemplary illustration of a sequence of steps for completing product registration via a telephone and/or voice response unit server associated with the manufacturer according to an embodiment of the present invention.

FIGS. 8(a)-(c) are exemplary illustrations of web pages for completing product registration via a manufacturer's Website.

FIGS. 9(a)-(c) are exemplary illustrations of information contained in various database at a manufacturer's location.

### DETAILED DESCRIPTION OF THE PREFERRED EMBODIMENT

The present invention is directed to a method and system and for automating product registration of one or more products by transmitting product registration information generated at the time of purchase to a manufacturer for subsequent completion of the registration of at least one of the one or more products automatically by the manufacturer or by the customer.

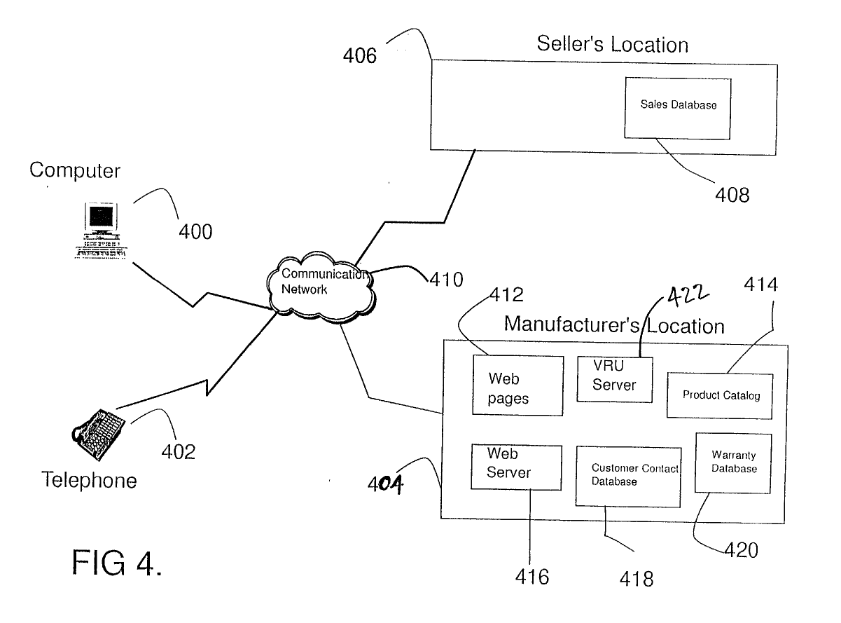

FIG. 4 is an exemplary representation of system architecture for product registration according to the present invention. Preferably, the system architecture of FIG. 4 is a client-server environment, which comprises a personal computer 400 (i.e., client) for communicating with a seller's location or associated seller's location or associated Website 406 and a manufacturer's location or associated Website 404. Alternatively, a telephone 402 is interconnected via network 410 to seller's location or associated Website 406 and manufacturer's location or associated Website 404. Network 410 may include an Intranet/Internet communication network, a wireless or landline telecommunication network, or a combination thereof.

Now referring to FIG. 4, computer 400 is a personal computer (“PC”) or a laptop computer. Computer 400 has an operating system, such as Windows 95/98/NT, Linux or other comparable operating system. Furthermore, computer 400 includes appropriate hardware adapters and/or network adapters for connecting to the communication network 410. The hardware adapters may include a conventional modem (e.g., 56 Kbps modem), cable modem, digital subscriber line (“DSL”) modem, satellite and wireless receivers and suitable coders/decoders, while the network adapters may include token-ring or Ethernet and the like. Computer 410 has appropriate software drivers to utilize communication protocols, such as transmission control protocol/Internet protocol (“TCP/IP”) for communicating over communication network 410, or any other wireless/wired communication protocol. Computer 400 further includes a web browser and a dialer. The web browser may include any conventional web browser, such as Microsoft Internet Explorer™ or Netscape Navigator™, while the dialer may include AT&T's Global Network Dialer™.

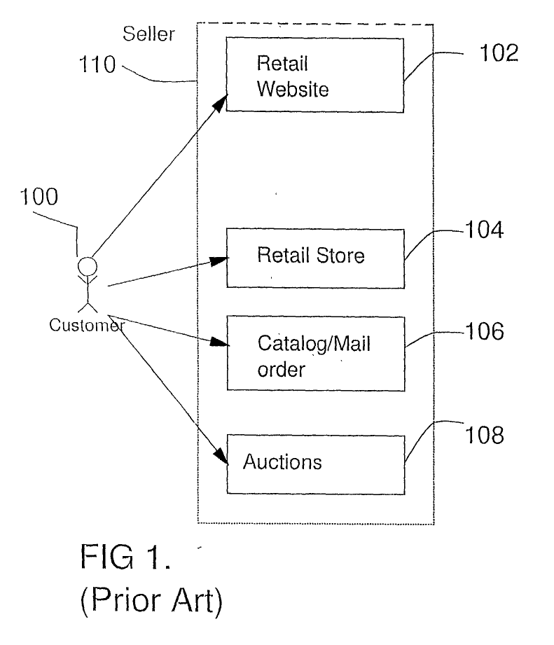

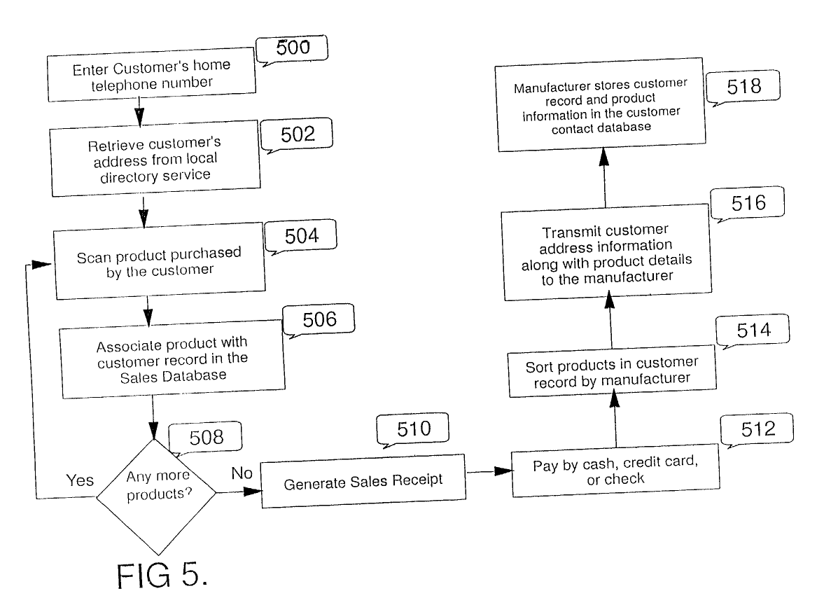

The exemplary seller's location or associated Website 406 of FIG. 4 comprises a computing infrastructure needed to capture information about sales of products by seller 110 to customer 100 (FIG. 1). The infrastructure includes a physical store, such as a point-of-sale (“POS”) terminal, which is described in greater detail herein below with reference to FIG. 5. The POS terminal is connected to a central computer (e.g., server computer), which captures sales transactions and updates a sales database 408, which records sales transactions of seller 110 of FIG. 1. For a seller 110 who has a presence on the Internet (e.g., Retail Website 102 of FIG. 1), the infrastructure includes one or more web servers for transacting sales transactions over the Internet. That is, the one or more web servers generate one or more web pages for depicting available products along with prices to customer 100, and for receiving payment information from customer 100.

Furthermore, the web server is responsible for updating sales database 408 after a sale transaction is completed for customer 100 as described herein below with reference to FIG. 5. The sales database 408 may be an IBM DB2™, an Oracle™ database, or the like.

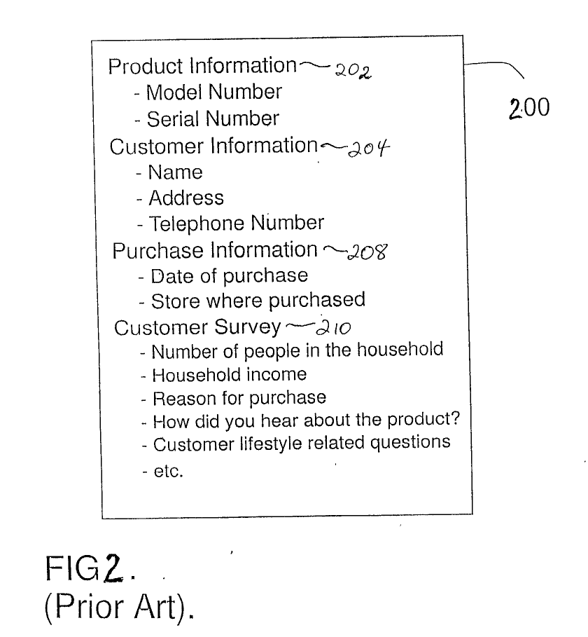

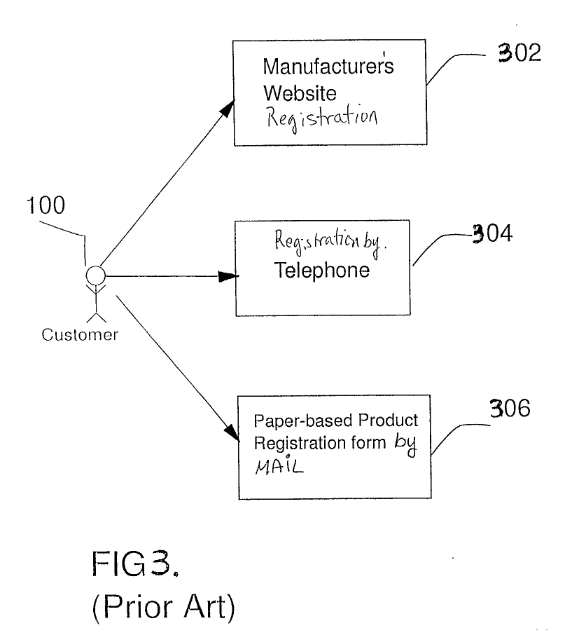

Further referring to FIG. 4, the Manufacturer's location or associated Website 404 includes web server 416 for processing customer requests and generating downloadable web pages 412, and may provide product catalog 414 either in hardcopy or downloadable electronic form (e.g., for Adobe Acrobat™ Reader, and the like), customer contact database 418 and warranty database 420 for recording information respectively associated with customers and warranties of products, and voice response unit (“VRU”) 422 for telephonically communicating with customers. Web server 416 includes web pages 412 needed for performing product registration according to the present invention. Customer contact database 418 includes or stores registration information, such as illustrated in FIG. 2, about customers that have purchased manufacturer's products.

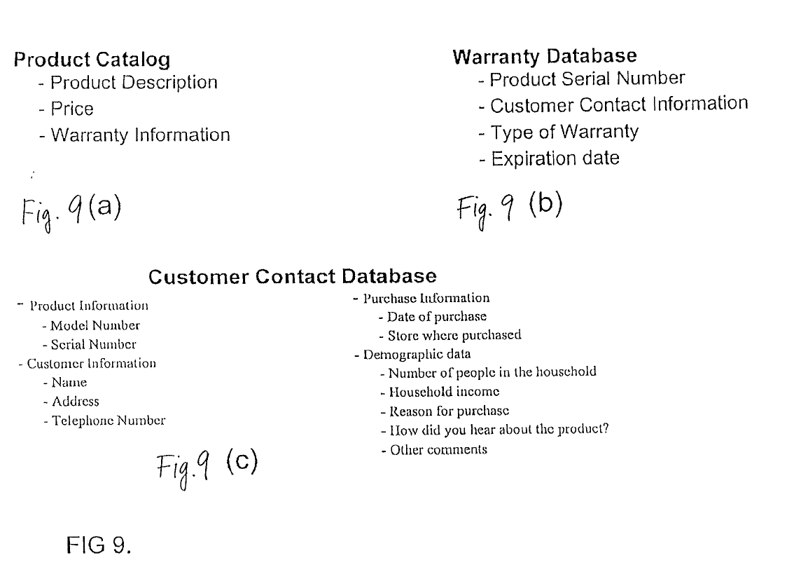

FIG. 9(c) illustrates exemplary information contained in customer contact database 418 (e.g., product information, customer information, purchase information and demographic information). Product catalog 414 includes information about products sold by a manufacturer, such as illustrated in FIG. 9(a) (e.g., product description, price and warranty information). Warranty database 420 includes warranty information for products manufactured by the manufacturer, such as illustrated in FIG. 9(b) (e.g., product serial/model number, customer contact information, type of product warranty and expiration date thereof). Web server 416 may be an IBM Risc System 6000 running AIX™ operating system, or a PC running Windows NT™ operating system. Web server 416 may further include IBM Websphere Application Server™ supporting Enterpise Java Beans™ technology and the like for handling user requests from computer 400. Product catalog database 414 may also be an IBM DB2™ or an Oracle™ database.

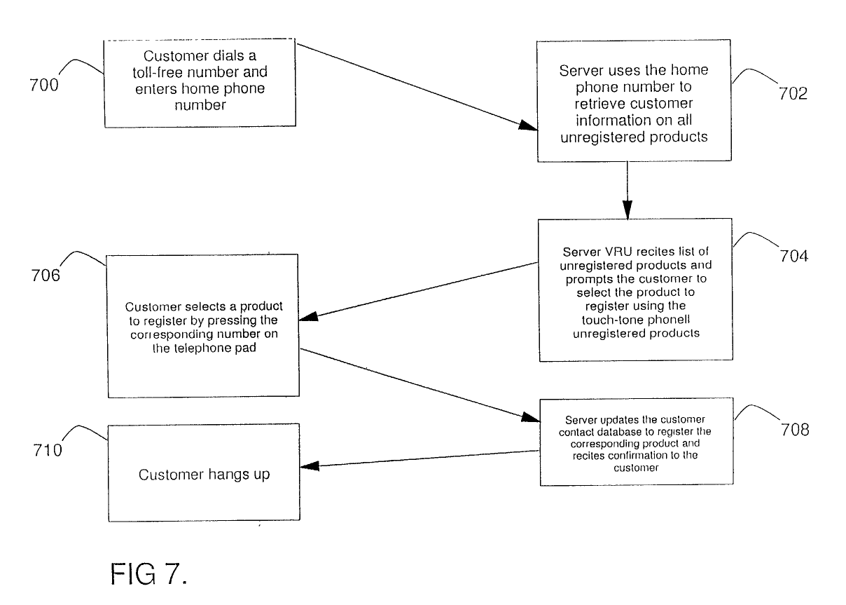

FIG. 5 illustrates a sequence of steps for product registration at a point of sale for customer 100 (i.e., FIG. 1) at a retail store 104 (i.e., FIG. 1) according to the present invention. A person of ordinary skill in the art will readily appreciate that the steps described herein below for product registration may easily be performed or adapted to other means for purchasing a product as illustrated in FIG. 1, such as a retail Website 102, mail order catalog 106 and auctions 108. After customer 100 selects one or more products for purchase, the customer 100 pays for the products at a point-of-sale (“POS”) terminal. A clerk managing the POS terminal requests that customer 100 provide customer's home telephone number (e.g., authorized home telephone). The use for the authorized home telephone number for customer 100 is described with reference to FIG. 7 herein below. At step 500, the clerk enters the home telephone number in the POS terminal. Preferably, the POS terminal is connected to a directory listing service and utilizes the home telephone number thus entered at step 502 to retrieve customer information (e.g., customer name and address) for the customer making the purchase at the POS terminal from the directory listing service. The directory listing service may be provided by retail store 104 by maintaining a database of customers or retail store 104 may subscribe to a third-party service provider (e.g., Verizon™ telecommunications). If multiple people live at that address, the directory listing service will retrieve a list of such people and the clerk may ask customer 100 to select the customer's name from the list. If the POS terminal is not connected to the directory listing service, or the directory listing service does not find the telephone number provided, or the customer is not on the retrieved list, the clerk may ask customer 100 to provide customer's name and address for input via the POS terminal. The POS terminal is optionally configured to receive additional information, such as customer's e-mail address via the POS terminal, and the customer may optionally provide such additional information at the time of purchase.

Subsequently to customer information (e.g., customer's name and address information) for customer 100 being entered into the POS terminal or retrieved from the directory listing service, products selected for purchase by customer 100 are scanned by the clerk using a conventional barcodes on the products at step 504. At step 506, as each product is scanned at the POS terminal (Step 504), information identifying each product (e.g., serial number, model number and the like) is automatically associated with a unique transaction record for customer 100 (FIG. 1) and stored in sales database 408 (FIG. 4). The clerk continues scanning products at step 504, until the clerk ascertains that there are no more products to be scanned at step 508. Once the products are scanned, at step 510, the clerk generates a sales receipt including a total amount due and customer 100 pays the stated total amount at step 512. Customer 100 may use conventional payment methods to pay the total amount due, such as cash, credit card, or check.

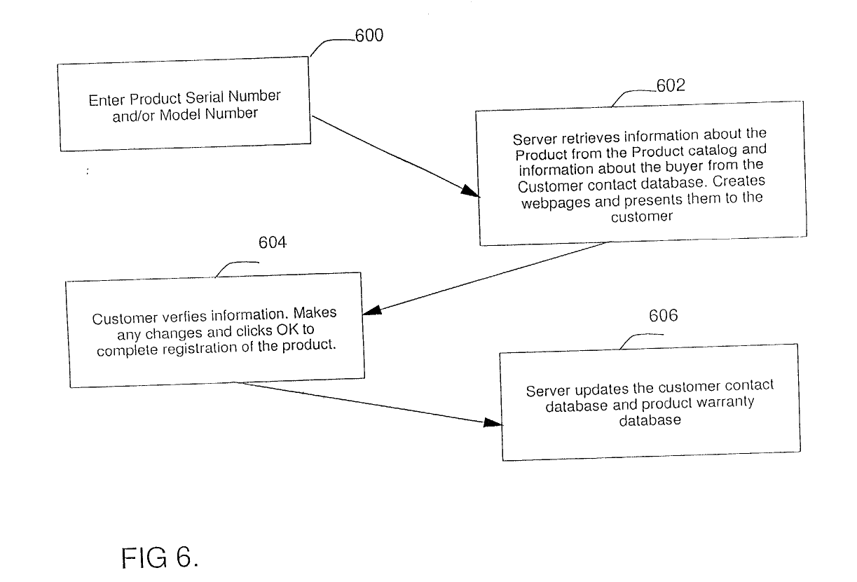

Upon completion of the sales transaction, at step 514, the POS terminal sorts the one or more products associated with customer record in step 506 by manufacturer and transmits via communication network 410 (FIG. 4) product registration information, including customer information (e.g., customer name and address information) and product information (e.g., serial number and model number) for the one or more products associated with each respective manufacturer to the respective manufacturer's location or associated Website 404 (i.e., FIG. 4). At step 518, each respective manufacturer's location or associated Website 404 that receives registration information stores the received registration information in its customer contact database 418 (i.e., FIG. 4) and waits for customer 100 to complete registration as described herein below with reference to FIGS. 6 and 7. It is contemplated that in lieu of storing registration information for customer 100 in its contact database 418 and waiting for customer 100 to complete registration, manufacturer's location or associated Website 404 may utilize received registration information to automatically complete registration for customer 100. It is further contemplated that upon automatic registration completion for the one or more products, manufacturer's location or associated Website 404 may further notify customer 100 via customer's e-mail address (if provided at time of purchase) or street address that the one or more products have been automatically registered, warranty for the one or more purchased has commenced, and any other information the manufacturer chooses to provide to customer 100.

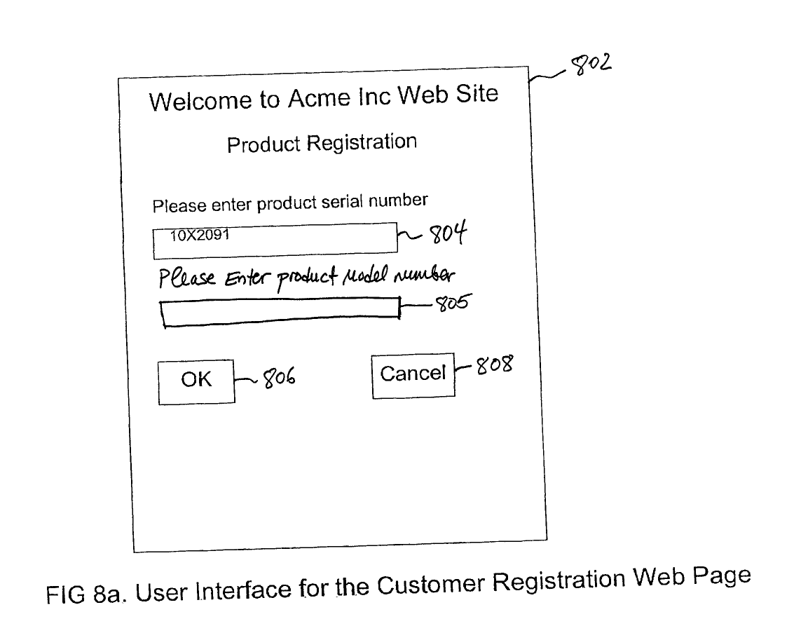

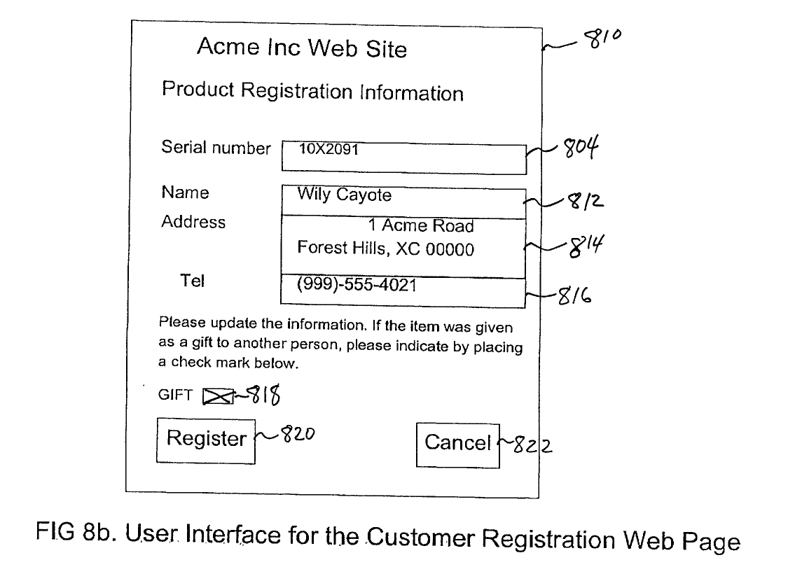

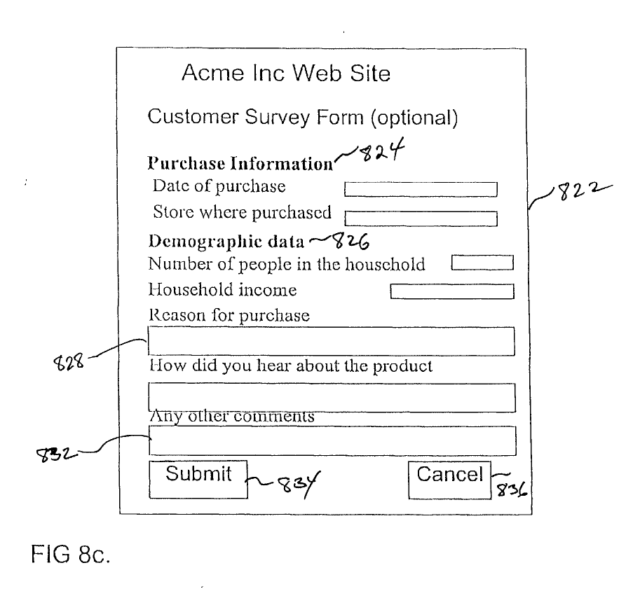

FIG. 6 is an exemplary illustration of a preferred embodiment for completing registration via manufacturer's location or associated Website 404. That is, FIG. 6 illustrates a sequence of steps for customer 100 to complete product registration via Website associated with manufacturer's location 404. To facilitate completion of product registration, a uniform resource locator (“URL”) for Website 404 associated with manufacturer's location is preferably provided or packaged together with the one or more products, or otherwise is disseminated to customer 100 of FIG. 1. In a first instance upon opening Web page 412 (not shown) represented by the URL, Website 404 associated with manufacturer's location may require customer 100 to create an account and obtain a customer ID and password for the account to protect customer's privacy and customer registration information. The account is created in a conventional way (not shown). Thus, once an account is created, customer 100 logs into customer's account at Website associated with manufacturer's location 404 utilizing customer ID and password. Preferably, after login, customer 100 is prompted to enter the serial number and/or model number for a purchased product at step 600 (e.g., described herein below with reference to FIG. 8(a)). Alternatively, after login, Website associated with manufacturer's location 404 displays product registration information, including customer information (e.g., customer name and address) and product information (e.g., serial number and/or model number) for the one or more purchased products for which registration has not yet been completed. At step 602, web server 416 retrieves registration information for the one or more products pending registration, including name and address information from customer contact database 418 and product information associated with the serial number and/or model number from product catalog 414, and creates one or more web pages 412 for displaying the foregoing registration information to customer 100 (e.g., as described hereinafter with reference to FIGS. 8(b)-(c)). At step 604, customer 100 verifies the product registration information thus displayed and proceeds to complete registration for products pending registration by depressing a “Register” button, or the like (e.g., described hereinafter with reference to FIG. 8(b)). A person of ordinary skill in the art will readily appreciate that Website associated with manufacturer's location 404 enables customer 100 to update/modify registration information, in case errors exist in the product registration information or when one or more of the products comprise gifts given by customer 100 to a donee. Upon depressing the “Register” button at step 606, web server 416 updates customer contact database 418 and warranty database 420 to reflect that the one or more products have been registered and to commence product warranty coverage for the one or more products. It should be noted that for each product, a manufacturer establishes and associates a default warranty coverage period for that product, and stores that information in warranty database 420. The default warranty coverage period varies among products from no warranty, to limited one-year warranty, to parts only warranty, to parts and labor warranty, or to some other coverage period determined by the manufacturer. Thus, when product warranty coverage for the one or more products is commenced, the default warranty coverage period determined and associated with each product by the manufacturer commences. In addition, the default warranty coverage period may be extended so as to support extended warranty purchases, which are purchased by customer 100. In the case one or more products were given as a gift, manufacturer location or associated Website 404 notes that the one or more products were given as gifts (e.g., described herein below with reference to FIG. 8(b)) and registration remains pending until recipient (i.e., donee) of the gift logs in to manufacturer or associated Website 404 to complete registration in the same manner as described.

FIGS. 8(a)-(c) illustrate exemplary web pages for completing product registration via a Website associated with manufacturer's location 404 of FIG. 4. FIG. 8(a) illustrates web page 802 enabling customer 100 to enter product serial number 804 and/or model number 805 for a product purchased by the customer 100. Upon entering product serial number 804 and/or product model number 805, customer 100 is enabled to continue with completing product registration by depressing “OK” button 806 or to cancel product registration by depressing “Cancel” button 808. After “OK” button is clicked, web page 810 of FIG. 8(b) is displayed to customer 100 via computer 400. FIG. 8(b) illustratively depicts product registration information that is presented to the user for verification and the information includes product serial number 804, customer name 812, customer address 814 and telephone number 816. As aforementioned with respect to FIG. 6, customer 100 is enabled via web page 810 to update/modify product registration information, in case errors exist in the foregoing product registration information or when one or more of the products comprise gifts given by customer 100. After customer 100 verifies registration information, the customer is enabled to complete registration for the purchased products that are pending registration by depressing “Register” button 820 or canceling registration by depressing “Cancel” button 822. For a product purchased as gift, gift checkbox 818 may be checked by customer 100 so that manufacturer's location or associated Website 404 is made aware or records that a person other than customer 100 (i.e., donee) will be registering the product and commencing warranty on the product. FIG. 8(c) is an exemplary web page 822 that requests customer 100 to fill out an optional customer survey. The survey includes purchase information 824, demographic information 826, reasons for purchasing the product 828, comments 832, and the like. Upon completing the survey, customer 100 is enabled to submit the survey via “Submit” button 834 or cancel the survey via “Cancel” button 836. Once completion of product registration is accomplished, Website associated with manufacturer's location 404 of FIG. 4 updates customer contact database 418 and warranty database 420 to indicate that the product has been registered and that product warranty has commenced.

FIG. 7 is an exemplary illustration of an alternate embodiment for completing registration. That is, FIG. 7 illustrates a sequence of steps for customer 100 to complete product registration via telephone 402 and voice response unit (“VRU”) server 422 at manufacturer's location or associated Website 404. A telephone number (e.g., 800-number or toll-free number) for manufacturer's location 404 is preferably provided or packaged together with the one or more products to facilitate completion of product registration via telephone 402 and VRU server 422, as illustrated in FIG. 4. At step 700 of FIG. 7, customer 100 dials manufacturer's toll-free number. VRU server 422 prompts the customer 100, via utilization of caller identification (if available), to confirm whether the customer is calling from customer's authorized home telephone recited by the VRU 422 to customer 100 through telephone 402. It should be noted that customer's authorized home telephone is obtained at the point of sale as described with reference to FIG. 5. If customer 100 is not making the call from customer's authorized home telephone, customer 100 speaks or enters customer's authorized home telephone number. At step 702, VRU server 422 utilizes the authorized home telephone number to retrieve from customer contact database 418 product registration information, including customer information (e.g., customer's name and address, and the like) and product information (e.g., serial number/model number) for the one or more products for which completion of registration is pending. VRU server 422 at step 704 recites telephone keys (i.e., keypad numbers) corresponding to the one or more products remaining unregistered for customer 100 and queries customer to enter or speak a number corresponding to each product for which registration is to be completed, or a number corresponding to all products for which registration is to be completed. At step 706, customer 100 selects a product or all products for which completion of registration is sought by entering or speaking a corresponding number. At step 708, VRU server 422 updates customer contact database 418 and warranty database 420 to complete registration for a product or all products corresponding to the number entered by customer 100, and confirms to customer 100 that warranty coverage for the product or all products has been commenced. Upon successfully confirmation of warranty, customer 100 hangs up telephone 402 at step 710. It is further contemplated that after registration a confirmation of warranty coverage may be e-mailed or mailed via conventional mail to customer 100.

With further reference to FIG. 7, manufacturer's location or associated Website 404 may alternatively provide a representative (manufacturer's employee or agent acting on behalf of the manufacturer), who when contacted via the provided toll-free number by customer 100 via telephone 402, may manually enter/update the foregoing information necessary to complete registration of a product into warranty database 420 and contact database 418. Yet further, manufacturer's location or associated Website 404 may provide a paper registration form together with a product sold to customer 100, so that customer 100 may use conventional mail to communicate to the manufacturer that customer 100 has bought the product and wants to register it. Once information is received by mail, manufacturer (or agent acting on behalf of manufacturer) may manually enter/update the foregoing information necessary to complete registration into warranty database 420 and contact database 418. Thus, when necessary registration information is entered by either method, the manufacturer completes registration of the product and commences warranty.

While the invention has been particularly shown and described with respect to preferred embodiments thereof, it will be understood by those skilled in the art that the foregoing and other changes in form and details may be made therein without departing from the spirit and scope of the invention as particularly embodied in the appended claims.

Having thus described our invention, what we claim as new, and desire to secure by Letters Patent is:

1. A method for automating product registration for one or more products purchased by a customer from a seller with one or more manufacturers of said one or more products, comprising:
(a) acquiring customer information at a time of customer purchase of said one or more products;
(b) generating product registration information for a manufacturer;
(c) transmitting from said seller via a communication network to said manufacturer said product registration information; and
(d) completing product registration of at least one of said one or more products at said manufacturer by utilizing said product registration information thereby transmitted.

2. The method according to claim 1, wherein said step of generating product registration information further comprises a step of:
acquiring product information associated with said one or more products purchased by said customer.

3. The method according to claim 1, wherein said step of generating further comprises a step of:
associating said one or more products with a sales transaction record for said customer; and
sorting said transaction record by said manufacturer for subsequent transmission of product registration information associated with said manufacturer to said manufacturer.

4. The method according to claim 1, wherein said completing step is initiated by one of said customer and said manufacturer.

5. The method according to claim 1, wherein said customer information includes name, address and telephone number for said customer.

6. The method according to claim 1, further comprising a step of:
utilizing a telephone number provided by said customer at said time of purchase for retrieving said customer information from a directory listing service.

7. The method according to claim 6, further comprising a step of:
manually entering said customer information by said seller at said time of purchase if said customer information cannot be retrieved from said directory listing.

8. The method according to claim 1, further comprising steps of:
receiving at said manufacturer said product registration information; and automatically completing by said manufacturer said product registration by utilizing said product registration information.

9. The method according to claim 1, further comprising a step of:
logging onto a web site associated with said manufacturer by said customer; and
completing by said customer said product registration at said website associated with said manufacturer by utilizing said product registration information.

10. The method according to claim 9, further comprising a step of:
updating by said customer information and said product registration information at said website.

11. The method according to claim 9, further comprising a step of:
indicating by said customer that at least one product of said one or more products is a gift to a donee;
updating by said donee said product registration information at said website; and
completing by said donee product registration for said at least one product at said website.

12. The method according to claim 1, wherein said completing step further comprises the steps of:
establishing contact by said customer via said communication network with a voice response unit (“VRU”) server associated with said manufacturer;
obtaining by said VRU server a telephone number of said customer;
retrieving said product registration information of at least one of said one or more products at said manufacturer based on said telephone number thus obtained; and
communicating information by said VRU to said customer necessary for said customer to complete registration for said at least one of said one or more products.

13. The method according to claim 12, wherein said step of communicating information further comprises a step of:
associating a telephone pad number key with said at least one of said one or more products of said manufacturer for transmission to said customer.

14. The method according to claim 13, said method further comprising a step of:
communicating said telephone pad number key by said customer to said manufacturer.

15. The method according to claim 14, wherein said customer communicates said telephone pad number key by one of voice and manual entry.

16. The method according to claim 12, wherein said telephone number is automatically identified via a caller identification.

17. The method according to claim 12, wherein said telephone number is manually entered by said customer.

18. The method according to claim 12, wherein said telephone number is manually entered or spoken by said customer to said VRU server.

19. A system for automating via a communication network product registration of one or more products purchased by a customer from a seller with one or more manufacturers of said one or more products, comprising:
(a) a device for accumulating product registration information relating to said one or more products purchased by said customer and for communicating via said network said product registration information to a manufacturer;
(b) a device for receiving and storing at said manufacturer said product registration information for registration completion;
(c) a device for completing said product registration of at least one of said one or more products for said manufacturer, wherein said completing is performed by said customer or said manufacturer.

20. The system according to claim 19, wherein said product registration information includes customer information relating to said customer and product information relating to said one or more products.

21. The system according to claim 20, wherein said device for accumulating includes a mechanism for acquiring said product information.

22. The system according to claim 20, wherein said device for accumulating includes a mechanism for associating said one or more products with a sales transaction record and sorting said transaction record by said manufacturer for subsequent transmission of product registration information associated with said manufacturer to said manufacturer.

23. The system according to claim 20, wherein said device for accumulating includes a mechanism for retrieving said customer information from a directory listing service by utilizing a telephone number provided by said customer.

24. The system according to claim 20, wherein said device for accumulating includes a mechanism for manually entering said customer information if said customer information cannot be retrieved.

25. The system according to claim 19, wherein at least one of said one or more manufacturers includes a website for said customer to logon and complete said product registration.

26. The system according to claim 19, wherein at least one of said one or more manufacturers includes a voice response unit (“VRU”) server to facilitate said customer to complete said product registration by telephone.

27. The system according to claim 19, wherein at least one of said one or more manufacturers includes a mechanism for facilitating said customer to update product registration information.

28. The system according to claim 19, wherein said communication network includes: an Internet, Intranet and a telecommunication network.

29. The system according to claim 19, wherein said device for receiving and storing includes a mechanism for enabling a donee to complete said product registration of at least one of said one or more products for said manufacturer.

30. The system according to claim 19, wherein said device for completing registration includes a personal computer and a telephone.

31. A program storage device readable by a machine, tangibly embodying a program of instructions, executable by said machine to perform method steps for automating product registration of one or more products purchased by a customer from a seller with one or more manufacturers, comprising:
(a) acquiring customer information at a time of customer purchase of said one or more products;
(b) generating product registration information for a manufacturer;
(c) transmitting from said seller via a communication network to said manufacturer said product registration information; wherein completion of product registration of at least one of said one or more products at said manufacturer is accomplished by utilizing said product registration information thereby transmitted.
